(19) United States
(12) Patent Application Publication
(10) Pub. No.: US 2014/0279260 A1
(43) Pub. Date: Sep. 18, 2014

(54) BUSINESS PROMOTION SYSTEM AND METHODS THEREOF

(71) Applicant: Prium Inc., Redmond, WA (US)

(72) Inventor: Umesh J. AMIN, Redmond, WA (US)

(21) Appl. No.: 14/202,380

(22) Filed: Mar. 10, 2014

Related U.S. Application Data
(60) Provisional application No. 61/783,619, filed on Mar. 14, 2013.

(51) Int. Cl. G06Q 30/06

(52) U.S. Cl. CPC G06Q 30/0625
USPC 705/26.62

(57) ABSTRACT

The present invention provides a business promotion system and a method thereof. The system includes a profile creator module configured to facilitate creation of a user profile, wherein the user profile comprises a set of user desired products, services, and related attributes of the products and services. A locator module configured to facilitate a web search to locate and analyze one or more vendors comprising said user desired products, services, and related attributes of the products and services. A communication module configured to communicate information of the one or more vendors to the user via a preferred communication mode and an execution module configured to allow the user to purchase at least one of said products and services and complete the purchase transaction.

### CROSS-REFERENCE TO RELATED APPLICATION

This non-provisional patent application claims priority from the U.S. provisional patent application Ser. No. 61/783,619 filed on Mar. 14, 2013, the content of which is incorporated herein by reference.

### FIELD OF THE INVENTION

The present invention relates to business promotion system and methods thereof.

### BACKGROUND OF THE INVENTION

The widespread proliferation of the web and the rapid advancement in technologies related to web access on electronic devices has resulted in an exponential increase in web-based user traffic. Users are increasingly accessing the web for a variety of purposes. Such increase in number of users accessing the web has given a large platform to vendors and merchants for advertising, promoting and selling their products and services via internet. The internet search engines and the peeping internet marketers are constantly monitoring user's interest and preferences so that they end up clogging user's email and electronic screens with advertisements and promotions and as such users are bombarded with product and/or service promotions all around them.

Due to the presence of a multiple number of product and/or service promotions or websites, users may be required to keep track of all digital store fronts to keep track of their needs. In such conventional approach, users may end-up keeping track of a large number of digital sites to meet their lifestyle needs. Further, due to numerous products and/or service promotions via web or messages into the users email or electronic screen space, users learn to ignore those messages or end-up wasting a lot of time or energy to keep their email and electronic screen space clear of those distractions. However, if users conduct an inquiry about products or services via web or telephone, they are recommended all kinds of products and services related to the inquiry. Also, for each product or service requirement, the end user is required to prepare a separate request with specific preferences and attributes to help user achieve their desired products and services. However, in case the required product promotion is located, there may be many challenges to verify the offer and to complete the purchase transaction.

The current internet search functionality is very inefficient as the current recommendation engines used for product promotions are mostly inaccurate. Further, the current promotions based product fulfillments are labour intensive.

Accordingly, there exists a need for a system and associated method of business promotions that provide users with an efficient, reliable, hassle free product/service identifying and purchasing environment. Also, what is required is a system and associated method for business promotion that provides vendors with an efficient platform for sharing, advertising and selling their products/services without overwhelming their customers/users.

### SUMMARY OF THE INVENTION

In view of the foregoing disadvantages inherent in the prior-art, the general purpose of the present invention is to provide a business promotion system, a method and a computer-readable medium thereof that is configured to include advantages of the prior art, to overcome the drawbacks inherent in the prior art, and offering some added advantages.

In one aspect, the present invention provides a business promotion system. The business promotion system includes a profile creator module, a locator module, a communication module, and an execution module. The profile creator module is configured to facilitate creation of a user profile by a user, wherein the user profile comprises a set of user desired products, services and related attributes of the products and services. The user profile comprises pre-populated categories of products and services chosen from a group consisting of computers, electronics, office supply, travel, clothing, jewellery, groceries, video games, sports, toys and baby products, health and beauty, vacations, home improvements, home appliances, building materials, books, music and combinations comprising at least one of the foregoing. Further, the set of user desired products, services and related attributes of products and services comprises pre-populated categories of related attributes of the products and services corresponding to at least one of a user desired retailer, a user desired price, a user desired price range, a user desired interest, a user desired timeline, a user desired set, a user desired method of purchase, a user desired method of delivery and a user desired method of payment. Each attribute of the products or services can be categorized further as must have or like to have with default option for each attribute being like to have.

In another aspect, the locator module of the business promotion system of the present invention is configured to facilitate a web search to locate and analyze one or more vendors comprising said user desired products, services and related attributes of the products and services. The web search is facilitated by a search engine which is capable of searching said user desired products, services and related attributes of products and services at the vendor. Further, the search engine is configured to confirm availability of said products and services at a given merchant or vendor and is further configured to confirm legitimacy of the given merchant or a vendor. The search engine compiles said user desired products, services and related attributes of products and services and removes irrelevant options.

In another aspect, the communication module configured to communicate information of the one or more vendors to said user via a preferred communication mode. The preferred communication mode comprises to at least one of a user email id, a user Smartphone MMS or SMS, a voice call with interactive voice response system, and a specialized message system.

In another aspect, the execution module configured to allow said user to purchase at least one of said products and services and complete the purchase transaction.

In yet another aspect, the present invention provides a method for business promotion. The method comprises facilitating creation of a user profile by a user, wherein the user profile comprises a set of user desired products, services and related attributes of the products and services. The method further comprises facilitating a web search to locate and analyze one or more vendors comprising said user desired products, services and related attributes of the products and services. Furthermore the method comprises facilitating communication of information of the one or more vendors to the user via a preferred communication mode and allowing said user to purchase at least one of said products and services and complete the purchase transaction.

In another aspect, the present invention provides a computer-readable medium storing a set of instructions that when executed cause a computer to perform a method for business promotion. The method comprises facilitating creation of a user profile, wherein the user profile comprises a set of user desired products, services and related attributes of the products and services. The method further comprises facilitating a web search to locate and analyze one or more vendors comprising said user desired products, services and related attributes of the products and services. Furthermore the method comprises facilitating communication of information of the one or more vendors to the user via a preferred communication mode and allowing the user to purchase at least one of said products and services and complete the purchase transaction.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, in which:

FIG. 1 depicts an overview of an environment in which various embodiments of the present invention may be practised;

FIG. 2 is a block diagram of a business promotion system, according to an exemplary embodiment of the present invention;

FIG. 3 illustrates an exemplary user interface for facilitating creation of a user profile, according to an exemplary embodiment of the present invention; and

FIG. 4 illustrates a flow diagram of a method for business promotion, according to an exemplary embodiment of the present invention.

### DETAILED DESCRIPTION OF THE INVENTION

The exemplary embodiments described herein information for illustrative purposes are subject to many variations in structure and design. It should be emphasized, however, that the present invention is not limited to a particular method and system for business promotion as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

In the following description, for purposes of explanation, specific information is set forth in order to provide a thorough understanding of the present invention. It will be apparent, however, to one skilled in the art that the present invention may be practiced without such specific information. As used herein, the term ‘plurality’ refers to the presence of more than one of the referenced item and the terms ‘a’, ‘an’, and ‘at least’ do not denote a limitation of quantity, but rather denote the presence of at least one of the referenced item. The term ‘device’ and ‘internet appliance’ or ‘internet enabled device’ has been used interchangeably and refer to mean the same thing.

The present invention provides methods and systems for business promotion. Pursuant to an exemplary scenario, for purchasing the products and services online, users have to visit several vendor websites for purchasing the desired product and services, such as electronics vendor websites, software vendor websites, book vendor websites and the like. Searched websites by the users may relate to the single vendor webpage or the webpage showing the products offered by multiple vendors. Searching different websites for purchasing the desired product and services may become time consuming and cumbersome for users who desire specific products with specific features without leaving a digital impression in the web for marketers to recommend other products. In such conventional approach, users may end-up keeping track of a large number of websites to meet their lifestyle needs. Once the right product promotion is found, there are many challenges to verify the offer and complete the purchase transaction. Such existing solutions are vendor push based business promotions. Various embodiments of the present technology, however, provide methods and systems for business promotion which is specifically customer pull based business promotion that are capable of overcoming these problems and other obstacles and providing additional benefits.

FIG. 1 depicts an overview of an environment 100 in which various embodiments of the present invention may be practised. The environment 100 includes plurality of users, such as a user 102, a user 104 and a user 106. It is understood that the environment 100 is depicted to include three users for illustration purposes and that the environment 100 may include more than three such users. Each user from among the plurality of users is associated with an electronic device for communicating with a network 114 for accessing vendor's website such as an electronics vendor 116, a software vendor 118 and a book vendor 120. For example, the user 102 is associated with an electronic device 108, the user 104 is associated with an electronic device 110 and the user 106 is associated with an electronic device 112. Examples of the electronic devices 108-112 may include, but are not limited to smart phones, laptops, tablet computers, personal computers and such other electronic devices configured to enable the users 102-106 to communicate with the network 114 for accessing the vendor's website such as the vendor's website 116-120. Further, the network 114 is also used by vendors for advertisements and promotions of their product by sending their advertisements and promotion web pages into the users email id or electronic screens associated with electronic devices 108-112.

Pursuant to an exemplary scenario, the network 114 represents the web and the electronic devices 108-112 may access the network 114 (i.e. perform web access) over wired networks, wireless networks or any combination thereof. Examples of the wired networks may include the Ethernet, local area network (LAN), fiber-optic cable network and the like. Examples of wireless networks may include cellular networks like GSM/3G/CDMA networks, wireless LAN, Bluetooth or Zigbee networks and the like. An example of a combination of wired and wireless networks may include the Internet.

The term ‘vendor’ as used herein refers to a person or a company that sells goods or services or products to someone else in the economic production chain. Further, the term ‘vendor website’ as used herein refers to the vendor's web pages served from a single web domain. The vendor website is hosted on at least one web server, accessible via a network 114 such as the Internet or a private local area network through an Internet address known as a uniform resource locator. Examples of vendor's website may include, but are not limited to, an electronics product providing vendor website, software product providing vendor website, vacation service providing vendor website, office supply providing vendor website, travel services providing vendor website, clothing providing vendor website, jewellery providing vendor website, groceries providing vendor website, video games providing vendor website, sports tickets and accessories providing vendor website, toys and baby products providing vendor website, health and beauty providing vendor website, home appliances providing vendor website, building material providing vendor website, books providing vendor website, music providing vendor website and the like.

It is understood that the network 114 is depicted to include three vendor's website such as an electronics vendor, a software vendor and a book vendor (for vendor's website 116, 118 and 120, respectively) for illustration purposes and that the network 114 may include a plurality of such vendor's website. In some exemplary scenarios, the vendor's website may be created utilizing browser-supported programming languages, such as JavaScript, and mark-up languages, such as Hyper Text Markup Language (HTML), for facilitating vendor's website access through a web browser employed by electronic devices such as the electronic devices 108-112. Examples of the web browser may include any standard browsers used for accessing web accounts, such as a Microsoft “Internet Explorer” browser, a Google “Chrome” browser, an Apple “Safari” browser, a Mozilla “Firefox” browser and the like, or even proprietary browsers associated with the electronic devices.

Pursuant to an exemplary scenario, the users such as the users 102-106 may access several vendors website, such as the vendor's website 116-120 to product purchase experience. Such product purchase experience may become difficult and cumbersome for the users, as the users have to search several vendor website for fulfillment of their requirements. Further, the vendors for their product advertisements and promotions may send their advertisements and promotion web pages into the users email id or electronic screens associated with electronic devices 108-112. Such product advertisements and promotions may not be suitable for the specific user and hence can irritate the user. A system for business promotion is explained with reference to FIG. 2.

FIG. 2 is a block diagram of a business promotion system 200, according to an exemplary embodiment of the present invention. The business promotion system 200 (referred to hereinafter as system 200) is configured to manage user specific profile for purchasing user desired products and services based on user desired attributes. Such products and services may include, computers, electronics, office supply, travel, clothing, jewellery, groceries, video games, sports, toys and baby products, health and beauty, vacations, home improvements, home appliances, building material, books, music and the like.

Further, the related attributes may include a user desired retailer, a user desired price, a user desired price range, a user desired interest, a user desired timeline, a user desired set, a user desired method of purchase, a user desired method of delivery, a user desired method of payment and the like. In an embodiment, the system 200 may be implemented as an application within an operating system associated with a user device (such as an electronic device from among the electronic devices 108-112 explained with reference to FIG. 1) and the actual system is in the cloud or Software as a Service (SAS) platform. In an embodiment, the system 200 may be implemented as an application within an internet search profile such as Google plus and the actual system is in the cloud or SAS. In an embodiment, the system 200 may also be integrated within a user profile of an existing online shopping portal. In an embodiment, the system 200 may be integrated within a web browser associated with the user device. For example, the system 200 may be implemented as a browser plug-in associated with the web browser.

In an embodiment, the system 200 may also be implemented as an application for mobile technology platforms. In an embodiment, the system 200 may also be implemented as a standalone service for purchasing the user desired products, services and related attributes of products and services. It is understood that such implementations of the system 200 may entail a software-based implementation of various components of the system 200. However, it is noted that the various components of the system 200 as described hereinafter may be implemented using hardware, software, firmware or any combination thereof in the user device. Examples of the user device may include a personal computer (PC), a tablet PC, a personal digital assistant (PDA), a Smartphone, a mobile communication device, an Internet enabled television (or web TV), an internet enabled gaming console and the like.

In an embodiment, the system 200 includes a profile creator module 202, a locator module 204, a communication module 206 and an execution module 208. The profile creator module 202, the locator module 204, the communication module 206 and the execution module 208 may be communicatively associated with each other using a bus 210. Examples of the bus 210 may include a data bus, a control bus, an address bus, a serial bus, a bi-directional bus and the like. In an embodiment, the various components of the system 200, such as the profile creator module 202, the locator module 204, the communication module 206 and the execution module 208 may be implemented as hardware, software, firmware or any combination thereof. It is noted that in some embodiments, the system 200 may include fewer or more components than those depicted in FIG. 2.

In an embodiment, the profile creator module 202 is configured to facilitate creation of a user profile by a user, wherein the user profile comprises a set of user desired products, services and related attributes of the products and services. The user profile comprises pre-populated categories of products and services chosen from a group consisting of computers, electronics, vacations, office supply, travel, clothing, jewellery, groceries, video games, sports, toys and baby products, health and beauty, home improvements, home appliances, building material, books, music and combinations comprising at least one of the foregoing.

Further, the attributes of products and services comprises pre-populated categories of related attributes of the products and services. Examples of the related attributes of products and services may include, but are not limited to a user desired retailer, a user desired interest, a user desired price, a user desired price range a user desired timeline, a user desired set, a user desired method of purchase, a user desired method of payment. For example, if a user is interested in purchasing an electronic product, then user can select desired product among different categories of the electronic products and can further select the different attributes of said electronic product. Examples of electronic products may include but are not limited to HD TV, MP3 players, digital cameras, Music system and the like. Further their attributes may include but are not limited to mega pixels of the digital camera, weight, price range, brand(s), model(s) and the like.

Further related attributes may also include but are not limited to desired vendor (for example best buy and the like), current interest (for example exploring, research, purchase and the like), desired timeline, desired method of purchase (for example in-store pick-up, by delivery, by down load and the like), desired method of payment (for example electronic payment, credit card payment, CoD and the like. Each attribute of the products or services can be categorized further as must have or like to have with default option for each attribute being like to have.

In an embodiment, the user such as the users 102-106 may create their user profile. The creation of each user profile may involve the provision to select a user desired products, services and related attributes of products and services. The creation of the user profile is further explained with reference to FIG. 3.

FIG. 3 illustrates an exemplary user interface (UI) 300 for facilitating creation of a user profile, according to an exemplary embodiment of the present invention. As explained with reference to FIG. 2, in some embodiments, the system 200 may be implemented as an application within an internet search profile such as Google plus. In such a case, upon accessing the internet search profile, the profile creator module 202 of the system 200 may be configured to present a UI, such as UI 300, to the user on a display screen associated with the user device.

Further as explained with reference to FIG. 2, in some embodiments, the system 200 may also be integrated within a user profile of an existing online shopping portal. In such a case, upon accessing the existing online shopping portal, the profile creator module 202 of the system 200 may be configured to present a UI, such as UI 300, to the user on a display screen associated with the user device. Further as explained with reference to FIG. 2 may be implemented as an application for mobile technology platforms.

As used herein, “mobile technology platforms” also commonly known as mobile OS, is the Operating System that operates smart phones, tablets, PDAs, or other digital mobile devices. In some embodiments, the system 200 may be implemented as an application within a web browser. In such cases, the profile creator module 202 of the system 200 may be configured to present the UI 300 upon accessing a menu option in a web browser. In some embodiments, the system 200 may be implemented as an application for mobile technology platforms. In such a case, upon accessing the mobile application, the profile creator module 202 of the system 200 may be configured to present a UI, such as UI 300, to the user on a display screen associated with the user device.

In some embodiments, the system 200 may be used as a standalone service. In such cases, the profile creator module 202 of the system 200 may be configured to present the UI 300, to the user on a display screen associated with the user device. It is noted that the creation of user profile is explained herein with reference to single set of a user desired products, services and related attributes of products and services using UI 300 in FIG. 3. However, it is understood that a plurality of such user profiles may be created by the user using UIs, such as the UI 300.

The UI 300 comprises a ‘select product and services’ option 302. The select product and services option 302 includes a drop-down menu access option 312. Upon clicking on the drop-down menu access option 312, a plurality of options for selecting products and services corresponding to the products and services to be purchased is presented to the user. The plurality of options for selection includes options such as electronics 332, computers 334, books 336 and music 338. A user may select an option from among said plurality of options displayed upon clicking on the drop-down menu access option 312. It is understood that the options for selecting product and services option of the user profile are depicted for exemplary purposes and that a plurality of such options may be provided to the user.

Further, the selected product and services options may further include a drop-down menu option including related attributes of said product and services. For example the drop-down menu option 312 associated with electronics 332 may include further drop-down menu access option 322. Upon clicking on the drop-down menu access option 322, a plurality of options 340 for selecting electronics categories corresponding to the electronics products to be purchased is presented to the user which includes but are not limited to HD TV, MP3 players, digital cameras, music and the like.

It is understood that the options for selecting related attributes of the associated product and services option of the user profile are depicted for exemplary purposes and that a plurality of such options may be provided to said product and services option. Similarly drop-down menu options 324, 326 and 328 comprise plurality of options corresponding to the computers 334, books 336 and music 338 respectively.

Further, UI 300 includes selection fields 304, 306, 308 and 310 corresponding to attributes of said products and services related to a retailer, an Interest, a timeline and a method of payment respectively. The user may select an option from a drop down menu 314, 316, 318 and 320 associated with the retailer 304, the interest 306, the timeline 308 and the method of payment 310. The dropdown menu 314 associated with the attribute box retailer 304 may include but are not limited to “best buy” and the like. The dropdown menu 316 associated with the attribute box interest 306 may include but are not limited to exploring, research, purchase and the like. The dropdown menu 318 associated with the attribute box timeline 308 may include but are not limited to in store pickup, delivery, down load and the like. The dropdown menu 320 associated with the attribute box method of payment 310 may include but are not limited to electronic payment, credit card payment, CoD and the like.

It is understood that the options for selecting related attributes of the associated product and services option of the user profile are depicted for exemplary purposes and that a plurality of such related attributes may be provided to create a user profile. Upon creation of a user profile, the user may use the created user profile for purchasing and searching the desired products and services and related attributes of product and services.

The UI 300 further includes a ‘create profile’ clickable button 330, which may be clicked by the user upon completion of a provision of user profile related to the fields 302-310.

Referring now to FIG. 2, the profile creator module 202 is further configured to facilitate updating of at least one option from among the created user profile. For example, the user may wish to modify/update certain options such as the select product and services, the retailers, the interests, the timeline, the method of payment and the like. The profile creator module 202 may facilitate such a modification/updation by re-provisioning the UI 300 for receiving the new set of entry from the user.

In an embodiment, the locator module 204 is configured to facilitate a web search to locate one or more vendors comprising said user desired products, services and related attributes of the products and services. More specifically, upon creation of one or more user profiles as explained with reference to FIG. 3, the created one or more user profiles may be used for conducting search through a web search to find the user desired products and services. In an embodiment, the locator module 204 is configured to link the one or more user profiles to the web search using a plug-in application programming interface (API).

As explained above, in some cases, the user may update at least one user profile from among the one or more user profiles. The locator module 204 is configured to subsequently link the updated version of the at least one user profile to the web search. The web search is facilitated by a search engine which is capable of searching said user desired products, services and related attributes of products and services at the vendor. Further, search engine is configured to confirm availability of said products and services at a given merchant or vendor and is further configured to confirm legitimacy of the given merchant or a vendor. The search engine compiles said user desired products, services and related attributes of products and services as per the user profiles as explained with reference to FIG. 3 and removes irrelevant options and provides with the results comprising products and services as per the user profiles.

As used herein web search refers to a software program that searches vendor websites and databases to gather information that contains or is related to user desired products, services, and related attributes of products and services. Further, the search engine refers to software system that is designed to search for information on the World Wide Web. The search results are generally presented in a line of results often referred to as search engine results pages (SERPs). The information may be a specialist in web pages, images, information and other types of files. The search engines also mine data available in databases or open directories. The search engines also maintain real-time information by running an algorithm on a web crawler.

In an embodiment, the communication module 206 is configured to communicate information of the one or more vendors to said user via a preferred communication mode. More specifically, upon conducting search by the locator module 204 for one or more user profiles as explained with reference to FIG. 3, the searched one or more results comprising products and services as per the user profiles are effectively communicated to the user on a user preferred communication mode as per the user profiles. The preferred communication mode can be one of a user email id, a user Smartphone MMS or SMS, a voice call with interactive voice response system, and a specialized message system.

In an embodiment, the execution module 206 is configured to allow said user to purchase at least one of said products and services and complete the purchase transaction. More specifically, upon receiving the results comprising products and services as per the user profiles to the user preferred communication mode by the communicator module 206, the user can purchase desired product and services by seamless fulfillment of the product or service transaction. Further, the execution module 206 is configured to complete the purchase transaction with a single click or a few clicks as compared to existing purchase processes.

The present invention may be implemented in multiple scenarios. The present invention can be implemented as an application into Internet search profile with the service being implemented in the cloud or as a SAS. The Internet search profile includes but is not limited to Google+ and similar platforms. According to an exemplary embodiment, the implementation of the present invention as an application into the Internet search profile is done by incorporating a UI for business promotion system 200 as explained in FIG. 2 into the Internet search profile. For example, within the Google's server farm for SAS, expand the profile to incorporate user profile and perform search for the products and services enlisted in user profile. Such enhanced Internet search profile can power the Google+ to enable a richer product promotion and purchase experience.

In an alternative embodiment, the present invention can be integrated into a user profile of an existing online shopping portal. According to an exemplary embodiment, the implementation of the present invention into a user profile of an existing online shopping portal is done by incorporating the business promotion system 200 as explained in FIG. 2 into an existing online shopping portal. More specifically, the business promotion system 200 option is invoked from a user profile of an existing online shopping portal. In this embodiment, within the online server which commences the existing online shopping portal and farm for SAS, expand the profile to incorporate user profile and perform search for the products and services enlisted in user profile. Such enhanced Internet search profile comprising the user profile can power the customer to enable a richer product purchase experience and can further power the vendor to enable a richer product promotion. The existing online shopping portal includes but is not limited to Amazon and the like.

As used herein SAS refers to server attached storage. Specifically, SAS is a server performing a variety of tasks concurrently from running applications, manipulating databases, file/print serving, providing communications, and checking data-integrity to many housekeeping functions.

The present invention can be implemented as an application within a web browser associated with user device. According to an exemplary embodiment, the implementation of the present invention as an application into the web browser associated with the user device is done by incorporating UI for business promotion system 200 as explained in FIG. 2 into the web browser associated with the user device. More specifically, the business promotion system 200 option is invoked as an option in the web browser associated with the user device. Examples of the web browser may include any standard browsers used for accessing web accounts, such as a Microsoft “Internet Explorer” browser, a Google “Chrome” browser, an Apple “Safari” browser, a Mozilla “Firefox” browser and the like, or even proprietary browsers associated with the electronic devices. Such invoking creates additional new functionality in the web browser which can power the customer to enable a richer product purchase experience and further can power the vendor to enable a richer product promotion.

The present invention can be implemented as an application for mobile technology platforms. In this embodiment, the system 200 is invoked in the application user interfaces of the mobile phone operating system. The mobile phone operating system may include but is not limited to android and the like. Such invoking of the system 200 in the mobile phone or smart phone allows the user to populate the user profile for performing searches, communication of results and purchasing of the products as explained in FIG. 2.

The present invention can be integrated as an application within one of an operating system of the user device. According to an exemplary embodiment, the implementation of the present invention as an application is done by incorporating UI of the business promotion system 200 as explained in FIG. 2 into the operating system of the user device. More specifically, the business promotion system 200 option is invoked in the operating system of the user device. In this embodiment, within the SAS server farm associated with the operating system of the user device, all functions of the system 200 is implemented. Specifically, populating the user profile for performing searches, communication of results and purchasing of the products as explained in FIG. 2.

In another exemplary embodiment, the present invention provides user profile storage module configured to store one or more user profile, one or more previous transactions and other pertinent information for multiple device access. More specifically the present invention provides a secure back up of all the user profile, one or more past transactions and other pertinent information for multiple device access. In some embodiments, the profile storage module may be configured using one or more volatile memories, one or more non-volatile memories or a combination of volatile and non-volatile memories. Examples of volatile memory may include, but are not limited to, random access memory, dynamic random access memory, static random access memory, and the like. Examples of a non-volatile memory may include, but are not limited to hard disk, magnetic tape, optical disk, programmable read only memory, erasable programmable read only memory, electrically erasable programmable read only memory, flash memory, and the like.

As explained above, in some embodiments, the system 200 may be integrated within the operating system associated with the electronic devices for business promotions. Examples of the electronic devices may include, but are not limited to, Smartphones, laptops, tablet computers, personal computers, an Internet enabled WebTV, an Internet enabled game console and such other electronic devices. Examples of the operating system may include, but are not limited to, a Google Android, Microsoft Windows, an Apple MacOS and iOS and the like. In some embodiments, the system 200 may be integrated within the web browser. Examples of the web browser may include, but not limited to, a Microsoft “Internet Explorer” browser, a Google “Chrome” browser, an Apple “Safari” browser, a Mozilla “Firefox” browser and the like. A method for managing user credentials is explained with reference to FIG. 4.

FIG. 4 illustrates a flow diagram of a method 400 for managing user credentials, according to an exemplary embodiment of the present invention. The method 400 depicted in flow diagram may be executed by, for example, the system 200 of FIG. 2. Operations of the flowchart, and combinations of operation in the flowchart, may be implemented by various means, such as hardware, firmware, processor, circuitry and/or other device associated with execution of software including one or more computer program instructions. The operations of the method 400 are described with help of the system 200. However, the operations of the method 400 can be described and/or practiced by using any other system.

The method 400 starts at operation 402. At operation 402, creation of a user profile by a user is facilitated (for example, by the profile creation module 202 of the system 200). The user profile comprises pre-populated categories of products and services chosen from a group consisting of computers, electronics, vacations, home improvements, home appliances, building material, books, music and combinations comprising at least one of the foregoing. Further, the user profile comprises a set of user desired products, services and related attributes of products and services comprises pre-populated categories of related attributes of the products and services corresponding to at least one of a user desired retailer, a user desired interest, a user desired timeline, a user desired set, a user desired price, a user desired price range, a user desired method of purchase, a user desired method of delivery, and a user desired method of payment. The creation of user profiles may be facilitated by provisioning a UI, such as the UI 300, as explained with reference to FIG. 3.

At operation 404, a web search to find vendors comprising said user desired products, services and related attributes of products and services is facilitated (for example, by the locator module 204 of the system 200). In an embodiment, the web search is facilitated by a search engine which is capable of searching said user desired products, services and related attributes of products and services at the vendor. The search engine is configured to confirm availability of said products and services at a given merchant or vendor and is further configured to confirm legitimacy of the given merchant or a vendor. Further, the search engine compiles said user desired products, services and related attributes of products and services and removes irrelevant options.

At operation 406, communication of information of the one or more vendors to the user via a preferred communication mode is facilitated (for example, by the communication module 206 of the system 200). The preferred communication mode comprises to at least one of a user email id, a user Smartphone MMS or SMS, a voice call with interactive voice response system, and a specialized message system.

At operation 408, purchasing of at least one of said products and services and complete the purchase transaction is facilitated (for example, by an execution module 208 of the system 200). The execution module is further configured to complete the purchase transaction with least number of steps.

Without in any way limiting the scope, interpretation, or application of the claims appearing below, advantages of one or more of the exemplary embodiments disclosed herein include business promotion which is based on customer pull based product purchase experience, while precluding the existing vendor push based product promotions and marketing for purchase. The methods and systems of the present invention enable automated personalized and user preference based web searches for product promotions and purchasing.

The exemplary embodiments of the present invention include one or more computer programs stored or otherwise embodied on a computer-readable medium, wherein the computer programs are configured to cause a processor to perform one or more steps. A computer-readable medium storing, embodying, or encoded with a computer program, or similar language, may be embodied as a tangible data storage device storing one or more software programs that are configured to cause a processor to perform one or more steps. Such steps may be, for example, any of the steps/operations described herein. Additionally, a tangible data storage device may be embodied as one or more volatile memory devices, one or more non-volatile memory devices, and/or a combination of one or more volatile memory devices and non-volatile memory devices.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A business promotion system, comprising:
a profile creator module configured to facilitate creation of a user profile, wherein the user profile comprises a set of user desired products, services and related attributes of the products and services;
a locator module configured to facilitate a web search to locate and analyze one or more vendors comprising said user desired products, services, and related attributes of the products and services;
a communication module configured to communicate information of the one or more vendors to the user via a preferred communication mode; and
an execution module configured to allow the user to purchase at least one of said products and services and complete the purchase transaction.

2. The system of claim 1, wherein the user profile comprises pre-populated categories of products and services chosen from a group consisting of computers, electronics, office supply, travel, clothing, jewellery, groceries, video games, sports, toys and baby products, health and beauty, vacations, home improvements, home appliances, building materials, books, music and combinations comprising at least one of the foregoing.

3. The system of claim 1, wherein the set of user desired products, services, and related attributes of products and services comprises pre-populated categories of related attributes of the products and services corresponding to at least one of a user desired retailer, a user desired interest, a user desired price, a user desired price range, a user desired timeline, a user desired set, a user desired method of purchase, a user desired method of delivery, and a user desired method of payment.

4. The system of claim 1, wherein the web search is facilitated by a search engine which is capable of searching said user desired products, services, and related attributes of products and services at vendor websites and databases.

5. The system as claimed in claim 4, wherein the search engine is configured to confirm availability of said desired products and services at a given merchant or vendor and is further configured to confirm legitimacy of the vendor.

6. The system as claimed in claim 4, wherein the search engine compiles the user desired products and services based on related attributes of products and services; and removes irrelevant options.

7. The system of claim 1, wherein the preferred communication mode comprises of an email message, a MMS or SMS message, a voice call from an interactive voice response system, and a specialized message system.

8. The system of claim 1, further comprising a profile storage module configured to store one or more user profiles, one or more previous transactions, and other pertinent information for multiple device access.

9. The system of claim 1, wherein the system is implemented as an application within an internet search profile.

10. The system of claim 1, wherein the system is integrated into a user profile of an existing online shopping portal.

11. The system of claim 1, wherein the system is implemented as an application within a web browser associated with user device.

12. The system of claim 1, wherein the system is implemented as an application for mobile technology platforms.

13. The system of claim 1, wherein the system is integrated within one of an operating system of the user device.

14. A method for business promotion, the method comprising:
facilitating creation of a user profile, wherein the user profile comprises a set of user desired products, services, and related attributes of the products and services;
facilitating a web search to locate and analyze one or more vendors comprising said user desired products, services, and related attributes of the products and services;
facilitating communication of information of the one or more vendors to the user via a preferred communication mode; and
facilitating the user to purchase at least one of said products and services and complete the purchase transaction.

15. The method of claim 14, wherein the user profile comprises pre-populated categories of products and services chosen from a group consisting of computers, electronics, office supply, travel, clothing, jewellery, groceries, video games, sports, toys and baby products, health and beauty, vacations, home improvements, home appliances, building materials, books, music and combinations comprising at least one of the foregoing.

16. The method of claim 14, wherein the set of user desired products, services, and related attributes of products and services comprises pre-populated categories of related attributes of the products and services corresponding to at least one of a user desired retailer, a user desired price, a user desired price range, a user desired interest, a user desired timeline, a user desired set, a user desired method of purchase, a user desired method of delivery and a user desired method of payment.

17. The method of claim 14, wherein the web search is facilitated by a search engine which is capable of searching said user desired products, services, and related attributes of products and services at the vendor websites or databases.

18. The method as claimed in claim 17, wherein the search engine is configured to confirm availability of said products and services at a given merchant or vendor and is further configured to confirm legitimacy of the given merchant or a vendor.

19. The method as claimed in claim 17, wherein the search engine compiles said user desired products and services based on related attributes of products and services; and removes irrelevant options.

20. The method of claim 14, wherein the preferred communication mode comprises to at least one of an email, a MMS or SMS, a voice call from an interactive voice response system, and a specialized message system.

21. The method of claim 14, further comprising a user profile storage module configured to store one or more user profile, one or more previous transactions and other pertinent information for multiple device access.

22. The method of claim 14, wherein the method is integrated into an internet search profile.

23. The method of claim 14, wherein the method is integrated into a user profile of an existing online shopping portal.

24. The method of claim 14, wherein the method is integrated within a web browser associated with user device.

25. The method of claim 14, wherein the method is implemented as an application for mobile technology platforms.

26. The method of claim 14, wherein the method is integrated within one of an operating system of the user device.

27. A computer-readable medium storing a set of instructions that when executed cause a computer to perform a method for business promotion, the method comprising:
facilitating creation of a user profile, wherein the user profile comprises a set of user desired products, services, and related attributes of the products and services;
facilitating a web search to locate and analyze one or more vendors comprising said user desired products, services, and related attributes of the products and services;
facilitating communication of information of the one or more vendors to the user via a preferred communication mode; and
facilitating the user to purchase at least one of said products and services and complete the purchase transaction.

28. A computer-readable medium of claim 27, wherein the user profile comprises pre-populated categories of products and services chosen from a group consisting of computers, electronics, office supply, travel, clothing, jewellery, groceries, video games, sports, toys and baby products, health and beauty, vacations, home improvements, home appliances, building materials, books, music and combinations comprising at least one of the foregoing.

29. A computer-readable medium of claim 27, wherein the web search is facilitated by a search engine which is capable of searching said user desired products, services, and related attributes of products and services at vendor websites or databases.

30. A computer-readable medium of claim 27, wherein the preferred communication mode comprises of at least email message, a MMS or SMS message, a voice call from an interactive voice response system, and a specialized message system.
